(19) United States
(12) Patent Application Publication
(10) Pub. No.: US 2015/0206089 A1
(43) Pub. Date: Jul. 23, 2015

(54) PREDICTING INCENTIVE COMPENSATION FOR OPPORTUNITIES IN SALES PERFORMANCE MANAGEMENT SYSTEMS

(71) Applicant: Oracle International Corporation, Redwood Shores, CA (US)

(72) Inventors: Rohan Shetty, Bangalore (IN); Jayakrishnan Radhakrishnan, Bangalore (IN); John Michael Docherty, San Francisco, CA (US)

(73) Assignee: Oracle International Corporation, Redwood Shores, CA (US)

(21) Appl. No.: 14/160,558

(22) Filed: Jan. 22, 2014

(51) Int. Cl. G06Q 10/06; G06Q 30/02

(52) U.S. Cl. CPC G06Q 10/06398; G06Q 30/0217

(57) ABSTRACT

An aspect of the present disclosure provides an estimate of incentive compensation for opportunities in a sales performance management system (SPMS). In an embodiment, the SPMS computes incentive compensation for sales representatives based on completed transactions, and then formulates polynomials modeling the computed incentive compensation for each sales representative. The SPMS thereafter estimates incentive compensation for various opportunities based on the formulated polynomials. According to another aspect of the present disclosure, the SPMS is designed to compute the incentive compensation (for actual completed transactions) in batch-mode, while the sales representatives may interactively obtain estimates of incentive compensation for opportunities in real-time.

### BACKGROUND OF THE DISCLOSURE

1. Technical Field

The present disclosure relates to digital processing systems used for sales performance management and more specifically to predicting incentive compensation for opportunities.

2. Related Art

Sales performance management systems are often used for various phases of sales transactions. A sales transaction generally refers to selling of a product, a service, and/or a part/portion of the product/service (which are all generally hereafter referred to as a product) to a customer.

Thus, the phases of management of such transactions include, for example, maintaining a list of prospective customers, maintaining a list of opportunities (potential future sale transactions that can be pursued by a sales representative), tracking the state of various transactions, crediting each sales representative (including sales person and any associated team members) for contribution in various transactions, computing incentives (compensation that is determined by the sales transactions, typically in addition to regular compensation) for sales representatives for the transactions, etc.

There is often a need for predicting incentive compensation for opportunities. For example, such predictions can be used by sales representatives in selecting suitable opportunities to pursue. Aspects of the present disclosure provide for predicting incentive compensation for opportunities in sales performance management systems.

### BRIEF DESCRIPTION OF THE DRAWINGS

Example embodiments of the present disclosure will be described with reference to the accompanying drawings briefly described below.

FIG. 1 is a block diagram illustrating an example environment (computing system) in which several aspects of the present disclosure can be implemented.

FIG. 2 is a flow chart illustrating the manner in which incentive compensation is computed for opportunities, in one embodiment.

FIG. 3 is a block diagram illustrating the details of a sales performance management system in an embodiment.

FIGS. 4A and 4B together depict a first compensation plan as applicable to some combination of a product type/category and specific class of sales representatives, in an embodiment.

FIG. 5 depicts a table containing some of the completed transactions, in an embodiment.

FIG. 6 depicts the incentive compensation for a sales representative in relation to selling of a product, in an embodiment.

FIG. 7 depicts the best fit curve representing the polynomial computed for credit/transaction amount vs. measure, in an embodiment.

FIG. 8 depicts the best fit curve representing the polynomial computed for measure vs. incentive, in an embodiment.

FIGS. 9A and 9B together depict a second compensation plan, in an embodiment.

FIG. 10 depicts the incentive compensation for a sales representative according to the second compensation plan, in an embodiment.

FIG. 11 depicts the best fit curve representing the polynomial computed for aggregated credit amount vs. measure in accordance with the second compensation plan, in an embodiment.

FIG. 12 depicts the best fit curve representing the polynomial computed (by polynomials block 360) for aggregate measure vs. incentive in accordance with the second compensation plan, in an embodiment.

FIGS. 13A and 13B depicts a table storing the computed polynomials according to the first and second compensation plan respectively, in an embodiment.

FIG. 14 depicts an opportunities table in an embodiment.

FIGS. 15A and 15B together depict an example user interface using which a sales representative may estimate incentive compensation for different opportunities, in an embodiment.

FIG. 16 is a block diagram illustrating the details of a digital processing system in which several aspects of the present disclosure are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

An aspect of the present disclosure provides an estimate of incentive compensation for opportunities in a sales performance management system (SPMS). In an embodiment, the SPMS computes incentive compensation for sales representatives based on completed transactions, and then formulates polynomials modeling the computed incentive compensation for each sales representative. The SPMS thereafter estimates incentive compensation for various opportunities based on the formulated polynomials.

According to another aspect of the present disclosure, the SPMS is designed to compute the incentive compensation (for actual completed transactions) in batch-mode, while the sales representatives may interactively obtain estimates of incentive compensation for opportunities in real-time. That is, the response duration for obtaining the estimate is substantially small (e.g., not more than a few seconds) compared to in batch-mode (where processing cycles occur in intervals such as every week or once every few hours).

According to another aspect of the present disclosure, a compensation plan is specified associated with each combination of a sales representative and a product. The compensation plan further requires determination of a ‘measure’, which is used as an input for the computation of incentive compensation. Accordingly, one polynomial is formulated for the measure, and another polynomial is formulated for the incentive compensation, and the two polynomials are stored associated with the corresponding combination of sales representative and the product.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

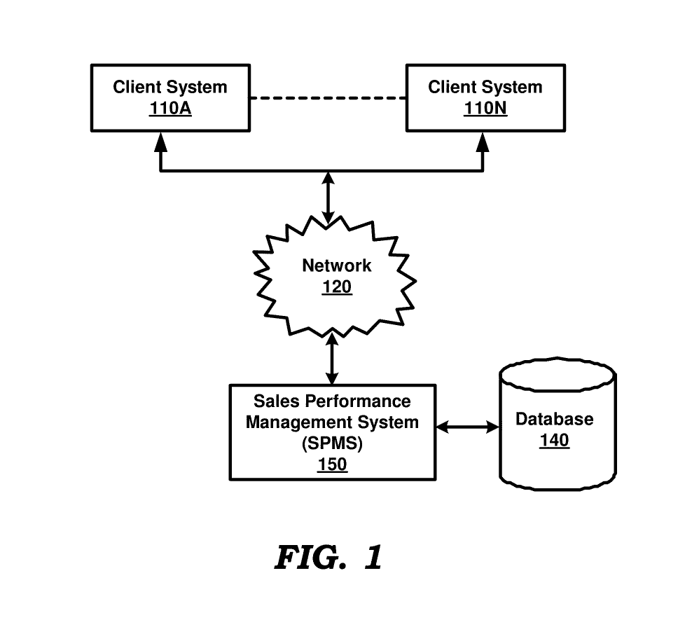

FIG. 1 is a block diagram illustrating an example environment (computing system) in which several aspects of the present disclosure can be implemented. The block diagram is shown containing client systems 110A-110N, network 120, sales performance management system (SPMS) 150 and database 140. Merely for illustration, only representative number/type of systems is shown in FIG. 1. Many environments often contain many more systems, both in number and type, depending on the purpose for which the environment is designed. Each block of FIG. 1 is described below in further detail.

Network 120 provides connectivity between client system 110A-110N and SPMS 150. Network 120 may be implemented using protocols such as Transmission Control Protocol (TCP) and/or Internet Protocol (IP), well known in the relevant arts. In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by network 120.

Database 140 represents a database server, and thus contains the database management software and hardware required for storing, accessing and modifying data based on structured queries. It is assumed that database 140 is a relational database containing various tables and records are stored in the respective rows of the tables. Thus, database 140 stores data related to sales performance management in the form of various tables.

Each of client systems 110A-110Z represents a system such as a personal computer, workstation, mobile device, etc., used by users to generate (user) requests directed to applications (including those for sales performance management) executing in SPMS 150. The requests may be generated using appropriate user interfaces. In general, a client system requests an application for performing desired tasks and receives corresponding responses containing the results of performance of the requested tasks.

SPMS 150 may be implemented as a single physical computer system unit, or contain multiple cooperating computer units. SPMS 150 provides various user interface features, which enable users (sales representatives) to manage various aspects of sales (including at least some of the several phases noted above). SPMS 150 provided according to aspects of the present disclosure, predicts incentive compensation for opportunities, as described below with examples.

### 3. Computing Incentive Compensation for Opportunities

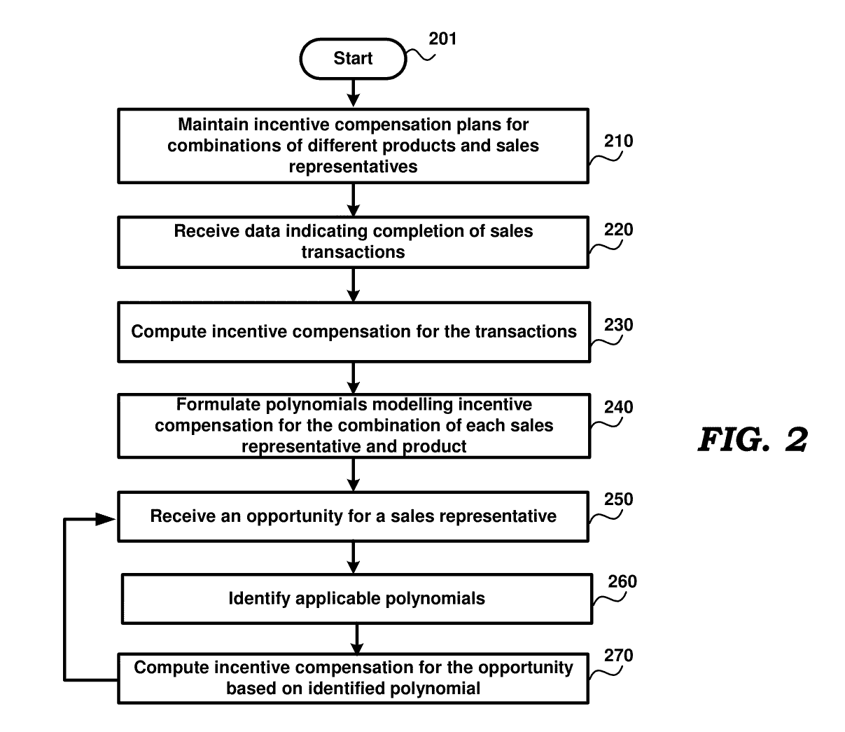

FIG. 2 is a flow chart illustrating the manner in which incentive compensation is computed for opportunities, in one embodiment. The steps of the flowchart are described with respect to the specific systems of FIG. 1 merely for illustration. However, the features can be implemented in other systems and environments also without departing from the scope and spirit of various aspects of the present disclosure, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present disclosure. The flow chart begins in step 201, in which control immediately passes to step 210.

In step 210, SPMS 150 maintains incentive compensation plans for combinations of different products and sales representatives. An incentive compensation plan specifies a computation approach based on which the incentive amount for a sales transaction can be computed, as applicable to each sales representative. The computation approach may be specified for each product, or alternatively products may be logically grouped as categories and compensation plans may be specified for such categories. In addition, each compensation plan may be applicable for a specific type of sales representatives or individuals, as specified by the organization.

In step 220, SPMS 150 receives data indicating completion of sales transactions. As may be readily observed, a sale transaction inherently specifies the specific product sold, and other attributes such as price and quantity.

In step 230, SPMS 150 computes incentive compensation for applicable sales representatives in relation to each of the completed transactions. The incentive compensation plans, in combination with the respective role (which is user specified), specify the computation logic for calculating the incentive amount for each sales representative. The incentive compensation for each applicable sales representative is accordingly computed. The incentive compensation may be in addition to some fixed compensation (such as monthly salary), and accordingly the total compensation for a sales representative may include both fixed compensation and incentive compensation.

In step 240, SPMS 150 formulates polynomials modelling incentive compensation for the combination of each sales representative and product. A product may be part of a category of products having the same compensation plan, in which case, the same polynomial is viewed as being applicable to all products of the category. As is well known, a polynomial is a mathematical expression formed of variables, called indeterminate, and coefficients connected by the operations of addition, subtraction, multiplication, and positive integer exponents. In the illustrative example below, only a single indeterminate is shown for illustration, though additional indeterminate can be used in alternative embodiments, as suitable in the corresponding environments. The polynomials thus computed may be stored in a non-volatile memory (e.g., database 140) for computing potential incentive(s), as described below.

In step 250, SPMS 150 receives identifiers of respective opportunities for a sales representative. The sales representative may be logged in from client system 110A and select one or more of the opportunities as a part of identifying suitable opportunities to pursue, causing data (identifier) representing the opportunity to be received.

In step 260, SPMS 150 identifies applicable polynomial(s) based on the combination of the sales representative (for whom the opportunity is received) and product (sought to be sold as a part of the opportunity). In other words, the specific polynomials for the combination of product and sales representative are selected (from the many polynomials computed in step 240).

In step 270, SPMS 150 computes the expected incentive compensation for the opportunity based on the identified polynomials. Assuming each polynomial is represented as an algebraic expression, computation (estimation) of the expected incentive compensation merely entails substitution of the appropriate provided values for the indeterminate(s) in the polynomial. Accordingly, the incentive compensation may be estimated based on the formulated polynomials.

Control is then shown as being transferred to step 250, in which next set (one or more) of opportunities may be selected for the desired estimation. It should be appreciated that the polynomials of step 240 may be formulated periodically at long intervals (say every month, o aligned with the batch processing of the computation of actual incentives in accordance with step 230), though not shown as such in FIG. 2.

The estimated compensation may be at variance with actual/accurate compensation, but such estimation may be valuable in several situations. The description is continued with respect to an example situation in an example embodiment of SPMS 150.

### 4. Example Implementation of SPMS

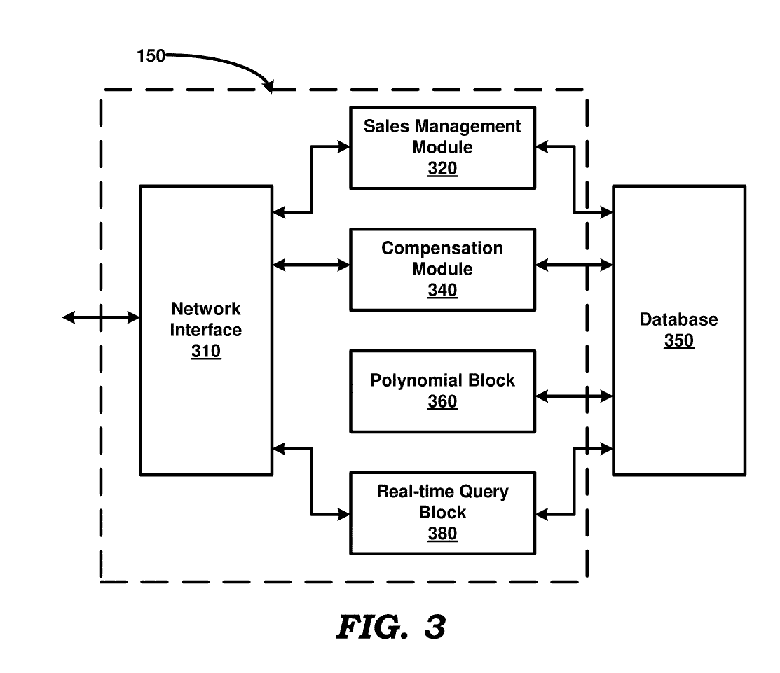

FIG. 3 is a block diagram illustrating the details of SPMS 150 in an embodiment. SPMS 150 is shown containing network interface 310, sales management module 320, compensation module 340, polynomial block 360, and real-time query block 380. Each block is described below in further detail below.

Network interface 310 provides the electrical and protocol interfaces (e.g., network cards, network protocol stacks, etc.) to enable various blocks of SPMS 150 to communicate via network 120. In general, packets directed to SPMS 150 are examined for forwarding to the appropriate internal block/module. Similarly, network interface 310 sends packets directed to other external systems (upon receipt of the corresponding packets from the respective block). Network interface 310 may be implemented in a known way. Database 350 may correspond to database 140, and stores the various details of sales transactions and compensation management, as described below with examples.

Sales management module 320 facilitates all phases of management of sales transactions, including enabling the management to indicate various opportunities that can be pursued by different sales representatives, updating the status (completed, in process, etc.) of each transaction pursued, indicating the credit amount (total revenue realized), etc. Information of each completed sale is also stored in database 350, with such information forming the basis for computation of incentive compensation.

Compensation module 340 computes the incentive compensation for each sales representative. The incentive computation may be based on various formulas, as typically configured by the management of the (selling) organization. The formulas are represented in the form of compensation plans, which may be specific to each category (type) of transactions and sales representative (type). Accordingly, the appropriate compensation plan is selected, as a part of computing the incentive compensation. The computed incentive is also stored in database 350.

Polynomial block 360 formulates the polynomial equations, based on incentive compensation previously computed (for completed transactions) by compensation module 340. Polynomial equations may be formed for any intermediate values, as required for the corresponding compensation plan. The polynomials may be formulated using, for example, various curve fitting approaches, well known in the relevant arts.

In an example approach described below, a polynomial is shown computed for measure output (which is an intermediate value representing the specific amount and the applicable duration/interval for which incentive compensation is to be computed, as applicable to the corresponding sales representative), and then for the estimated incentive based on the computed measure output. However, alternative approaches can be employed with more (or even a single) polynomials, as suited in the corresponding situation. The formulated polynomials are stored in database 350 (or other non-volatile storage) for later usage.

Real-time query block 380 receives opportunities indicated by a sales representative and indicates in real-time the estimated compensation. The estimation is performed by substituting the attributes such as product, amount/quantum, etc., associated with the indicated opportunity (or opportunities) in the applicable polynomials.

In an embodiment, compensation module 340 operates in a batch-mode (e.g., once every week or day) in view of, for example, the complexity of computations, to align with compensation cycles (e.g., fortnightly payments of salary) and also the large number of transactions that may need to be processed. In contrast, the estimation of incentive compensation may be performed in real-time (e.g., within utmost a few seconds typically) using the polynomials. The margin of error (or deviation from accurate value) depends on the formulation of polynomials, but reasonable deviations may be acceptable at least for the purpose of selection of opportunities to pursue.

The features noted above (and others) are described below in detail with two example compensation plans, as applied to same transactions for ease of understanding.

### 5. Polynomials for a First Compensation Plan

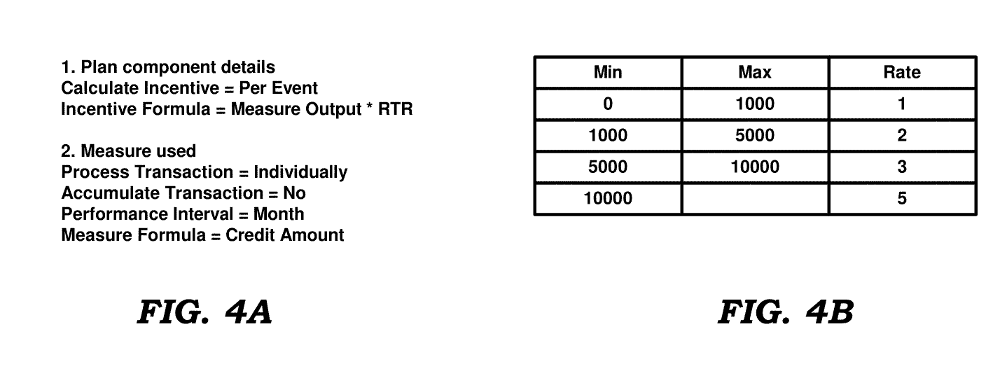

FIGS. 4A and 4B together depict a first compensation plan as applicable to some combination of a product type/category and specific class of sales representatives. In particular, FIG. 4A indicates that the Measure equals ‘credit amount’ and that the incentive is computed for each transaction ‘individually’. The incentive formula is given as ‘Measure’ multiplied by RTR (rate table rate). It may be appreciated that other formula such as gross margin percentage or gross margin quantum, can be used, and such formulas also may be observed to be based on revenue. Here credit amount may be viewed as revenue less any tax withholdings, etc.

FIG. 4B indicates the rate at different range of measure amounts. Thus, if the measure amount is between 1000 and 5000, the incentive compensation is set at 2%.

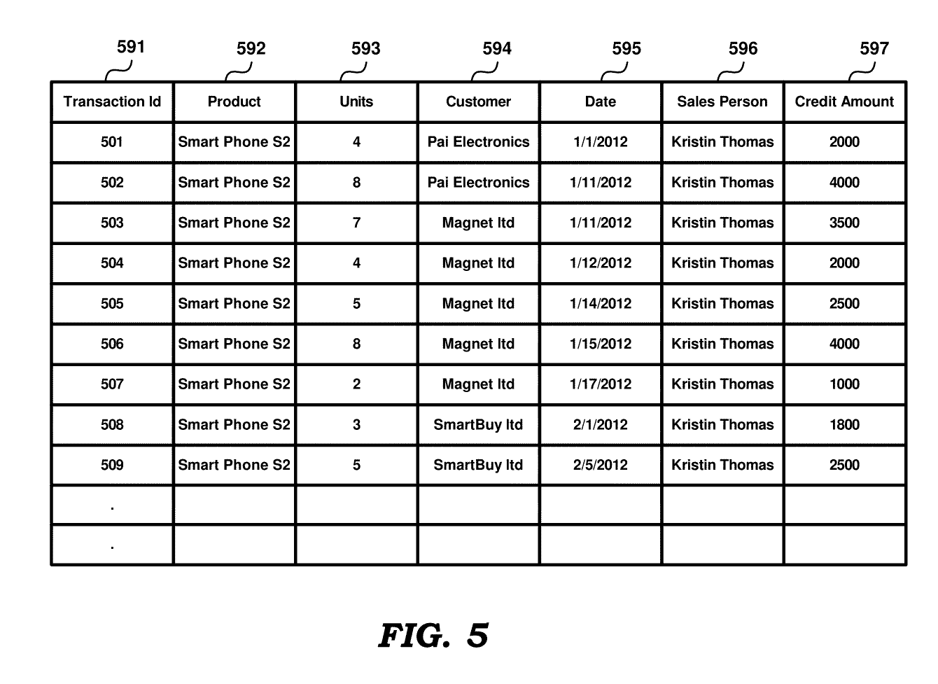

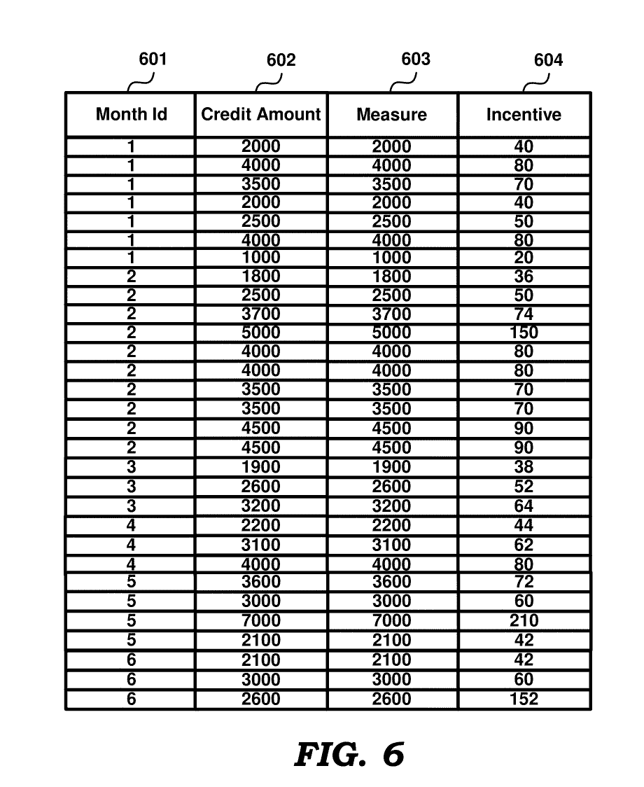

FIG. 5 depicts a table containing some of the completed transactions, which are stored in database 350. The table is populated and stored in database 350 by operation of sales management module 320. Though entries are shown only for a single product (in product 592) and for a single sales representative (in sales person 596), it should be appreciated that typical scenarios will have transactions related to many products from different sales representatives. Units 593, customer 594, date of transaction 595, and transaction identifier 591 are also shown. Each record/row represents a corresponding single transaction, based on a per unit price of 500.

FIG. 6 depicts the incentive compensation for Kristin Thomas (sales representative) in relation to selling of product Smart Phone S2. The table is populated and stored in database 350 by operation of compensation module 340. The table is shown containing month identifier 601 (extracted from date 595), credit amount 602 (equaling credit amount 597), measure 603 and incentive 604.

The measure is shown equaling the credit amount, consistent with the compensation plan of FIG. 4A. The incentive is shown computed according to the RTR table of FIG. 4B. FIG. 6 is shown containing transactions, in addition to those shown in FIG. 5.

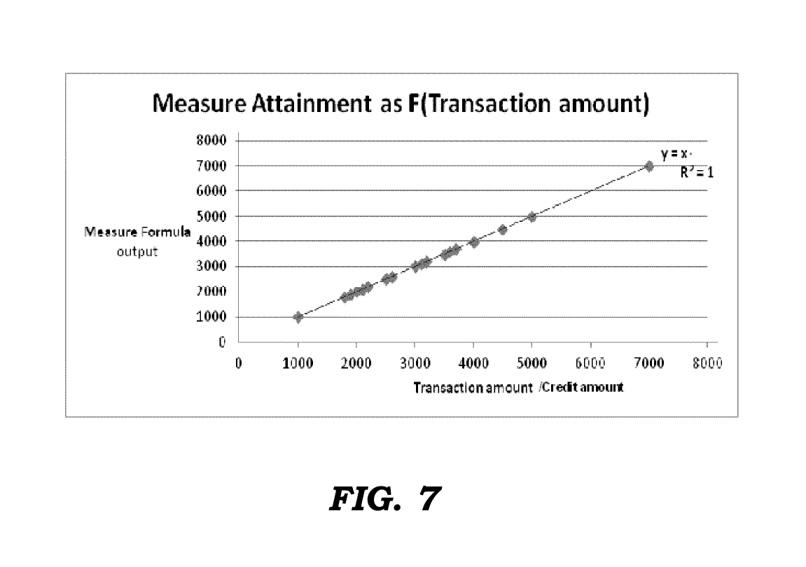

FIG. 7 depicts the best fit curve representing the polynomial computed for credit/transaction amount vs. measure. The graph there is shown containing the data points corresponding to transactions of FIG. 6. Given the linear relationship, the polynomial is represented as (Y=X, with credit amount represented by X and measure represented by Y).

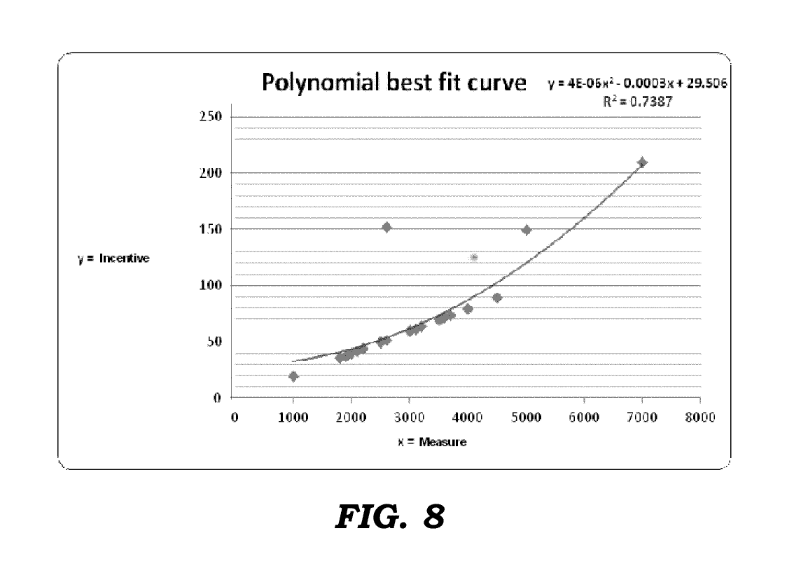

FIG. 8 depicts the best fit curve representing the polynomial computed (by polynomials block 360) for measure vs. incentive, again based on the transactions of FIG. 6. The relationship between measure (X) and incentive Y is shown represented by the polynomial (quadratic expression) (4Ê−06*X̂2−0.0003x+29.506), wherein E is a mathematical constant representing the base of the natural logarithm, ̂ represents the power symbol, and * represents multiplication.

The manner in which the polynomials are used by run-time query block 380 is described after the computation of polynomials for a second compensation plan.

### 6. Polynomials for a Second Compensation Plan

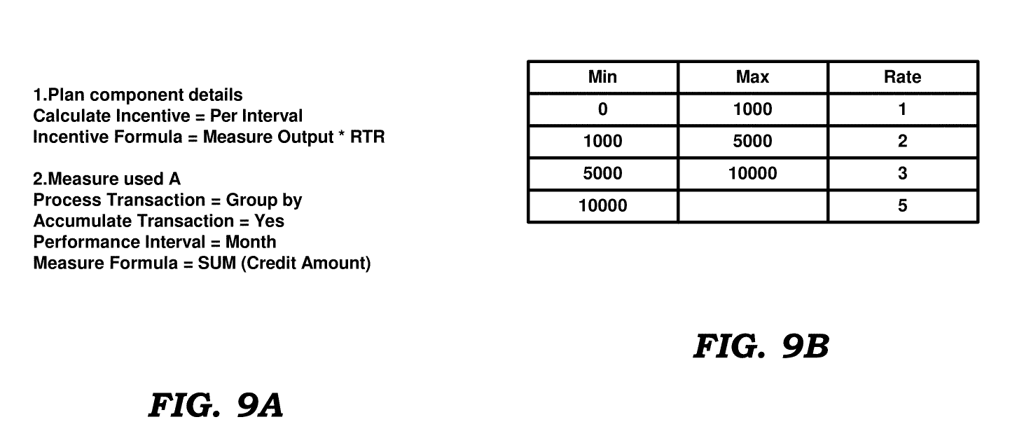

FIGS. 9A and 9B together depict a second compensation plan as applicable to Kristin Thomas for the ‘Smart Phone S2’. In particular, FIG. 9A indicates that the Measure is based on sum of credit amount aggregated over a month and that the incentive is computed each month. The incentive formula is given as ‘Measure’ multiplied by RTR (rate table rate).

FIG. 9B indicates the respective rates at corresponding different ranges of aggregate measured amounts. Thus, if the aggregate measure amount (in a month) is between 1000 and 5000, the incentive compensation is set at 2% of the aggregate measure amount.

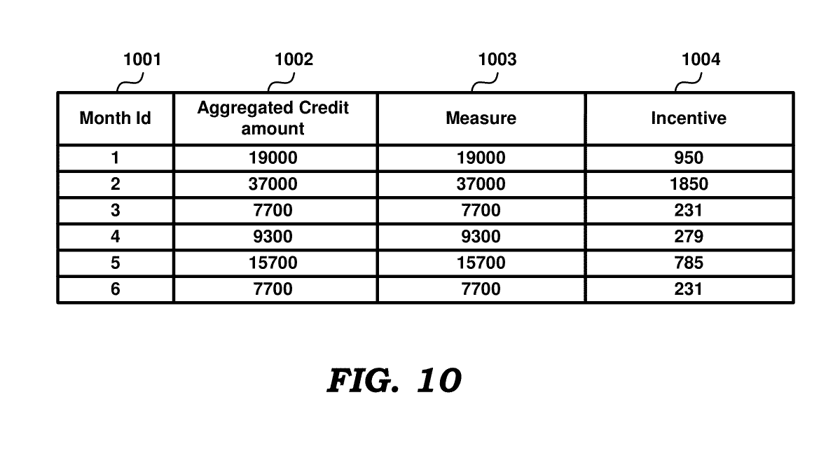

FIG. 10 depicts the incentive compensation for Kristin Thomas (sales representative) assuming the same transactions as in FIG. 5, but based on the compensation plan of FIGS. 9A/9B. The table is shown containing a row for each month. The table is shown containing month identifier 1001 (extracted from date 595), aggregated credit amount 1002 (equaling credit amount 597 aggregated in each month), measure 1003 and incentive 1004.

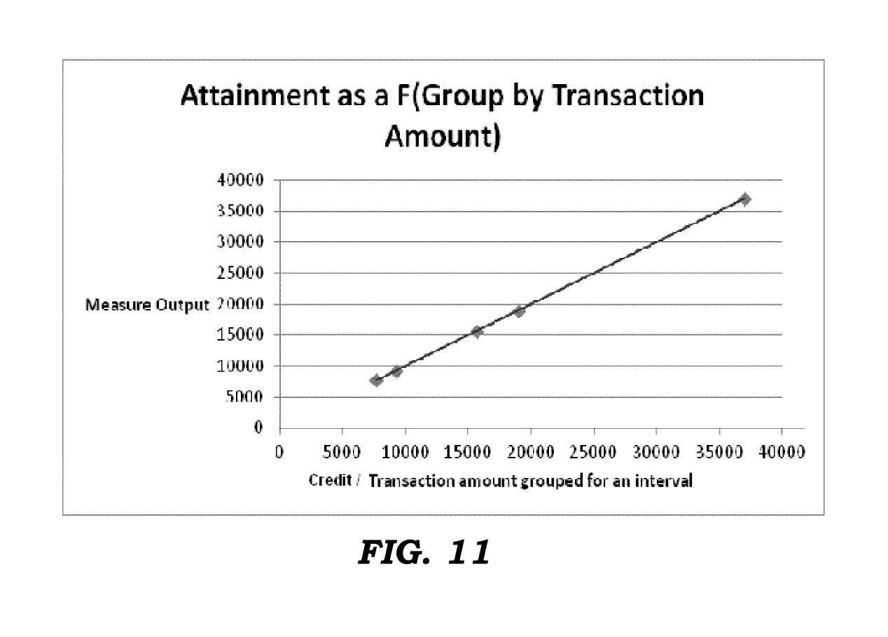

The measure is shown equaling the aggregated credit amount, consistent with the compensation plan of FIG. 9A. The incentive is shown computed according to the RTR table of FIG. 9B. FIG. 11 depicts the best fit curve representing the polynomial computed for aggregated credit amount vs. measure. Given the linear relationship, the polynomial is represented as (Y=X, with aggregated credit amount represented by X and measure represented by Y).

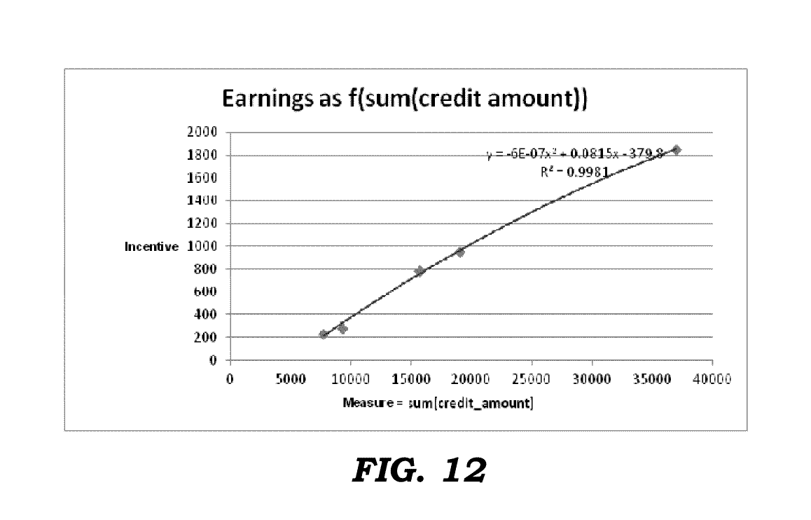

FIG. 12 depicts the best fit curve representing the polynomial computed (by polynomials block 360) for aggregate measure vs. incentive, with respect to the data in FIG. 10. The relationship between aggregate measure (X) and incentive Y is shown represented by the polynomial (quadratic expression) (−6Ê−07*X̂2−0.0815x−379.8), wherein E is a mathematical constant representing the base of the natural logarithm, ̂ represents the power symbol, and * represents multiplication.

It should be understood that the compensation plans and polynomials shown above are merely illustrative. Large enterprises often have much more complex and diverse requirements for various personnel in the organization chain, and the incentive compensation plans are accordingly more in number and complex as well.

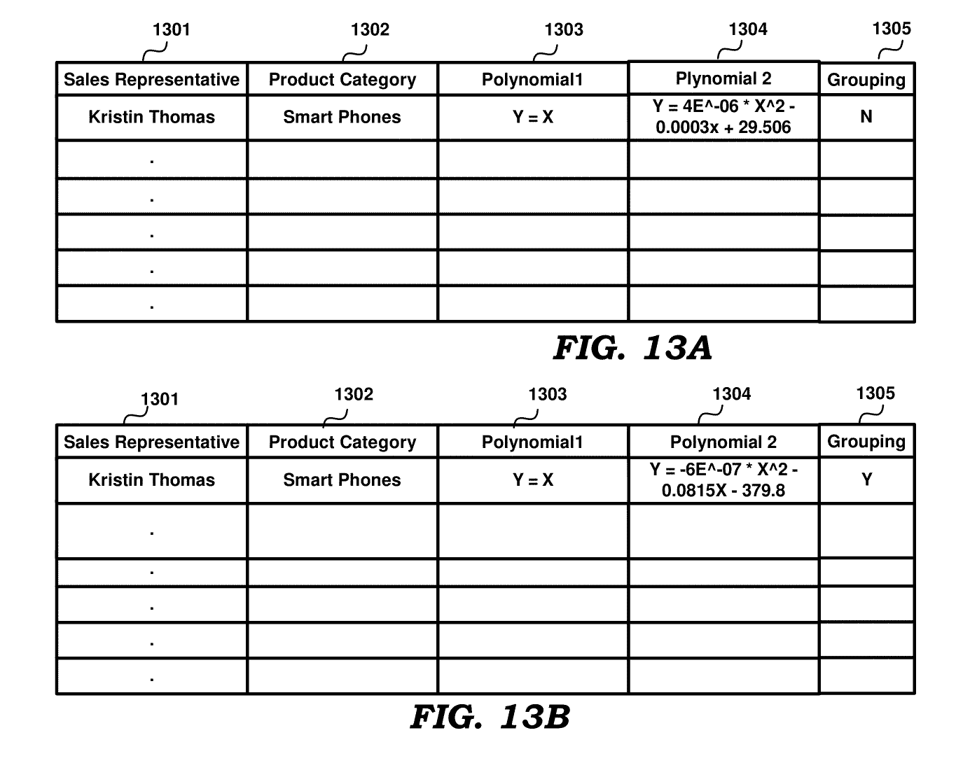

The polynomials thus formulated (based on historical data of actual transactions) may be stored in a corresponding table, as illustrated in FIGS. 13A and 13B. The table there is shown containing a row for a combination of each sales representative and a product category, and it is assumed that only two polynomials are required to be formulated for the corresponding incentive estimation. Accordingly, the table is shown containing columns for sales representative 1301, product category 1302, polynomial1 1303, polynomial2 1304, and grouping 1305.

The grouping column indicates whether each transaction is to be individually compensated. In FIG. 13A, the value corresponding to grouping 1305 for Kristin is shown as ‘N’, as corresponding to the first compensation approach above. In FIG. 13B, grouping 1305 for Kristin is shown as Y, as corresponding to the second compensation approach described above.

While a separate row is shown for each sales representative, a single formula may be stored for a category of sales representatives as well, in which case the formula is deemed to be applicable to all sales representatives falling within the category. The manner in which the polynomials thus saved can be used, is described below with additional examples.

### 7. Estimating Incentive for Opportunities

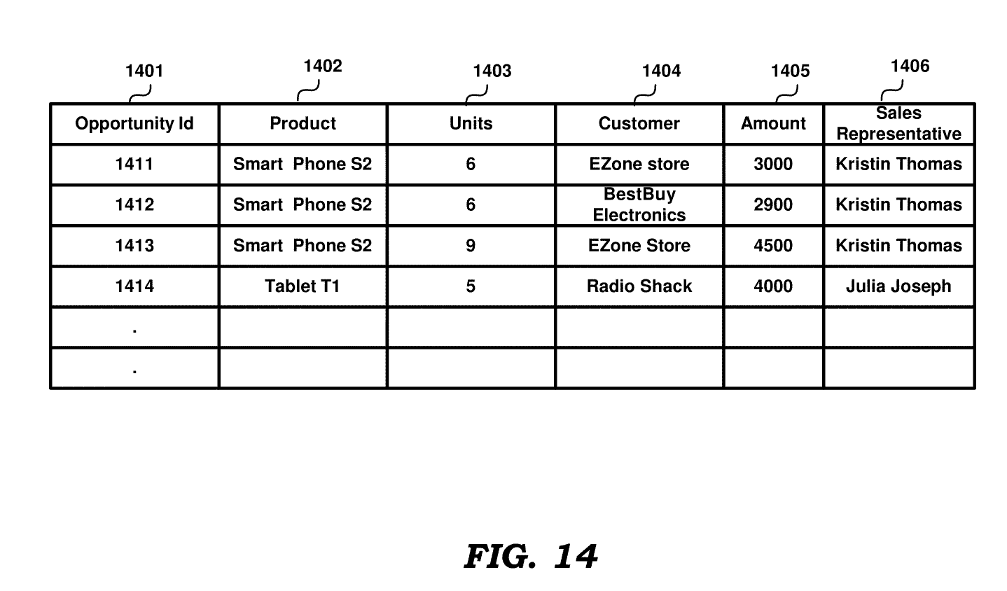

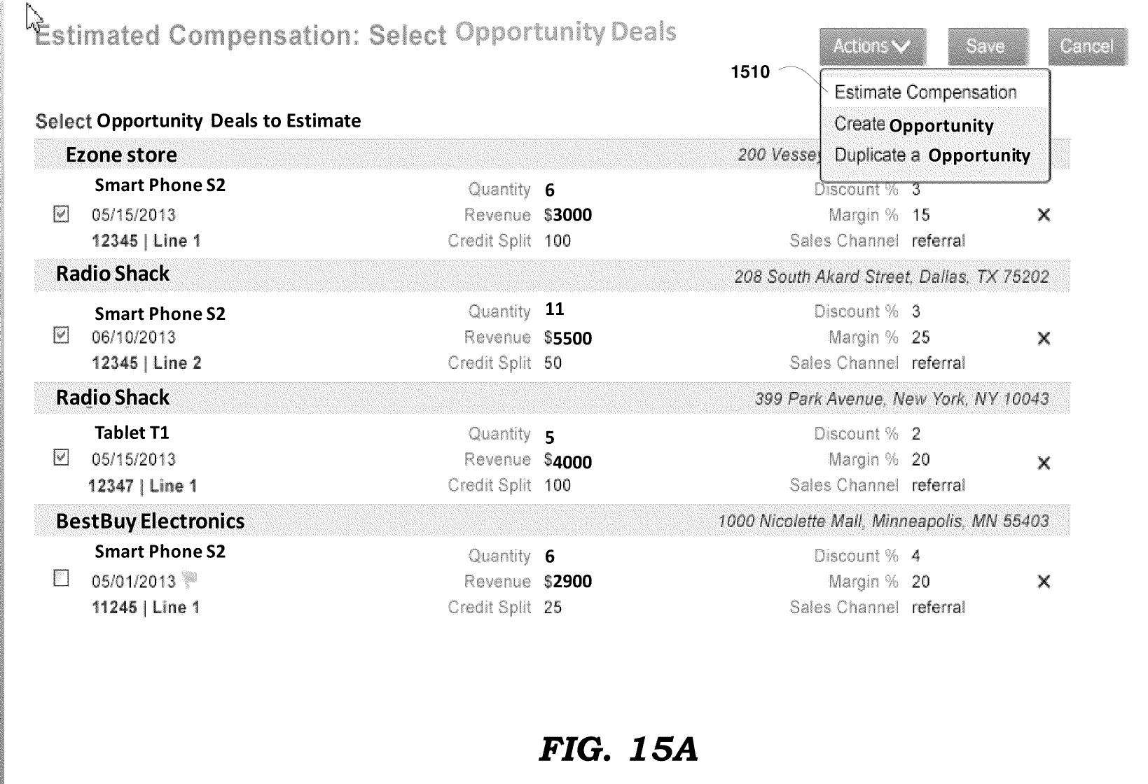

In an embodiment of the present disclosure, sales management module 320 maintains a table in database 350, indicating the various opportunities that can be pursued by a sales representative. FIG. 14 depicts such an opportunities table in an embodiment. The table is shown containing a row for each opportunity. The table also contains columns for opportunity identifier 1401, product 1402, units 1403, customer 1404, amount 1405 and sales representative 1406. While a few representative opportunities are shown for illustration, large organizations typically have many more opportunities that the sales representatives can pursue.

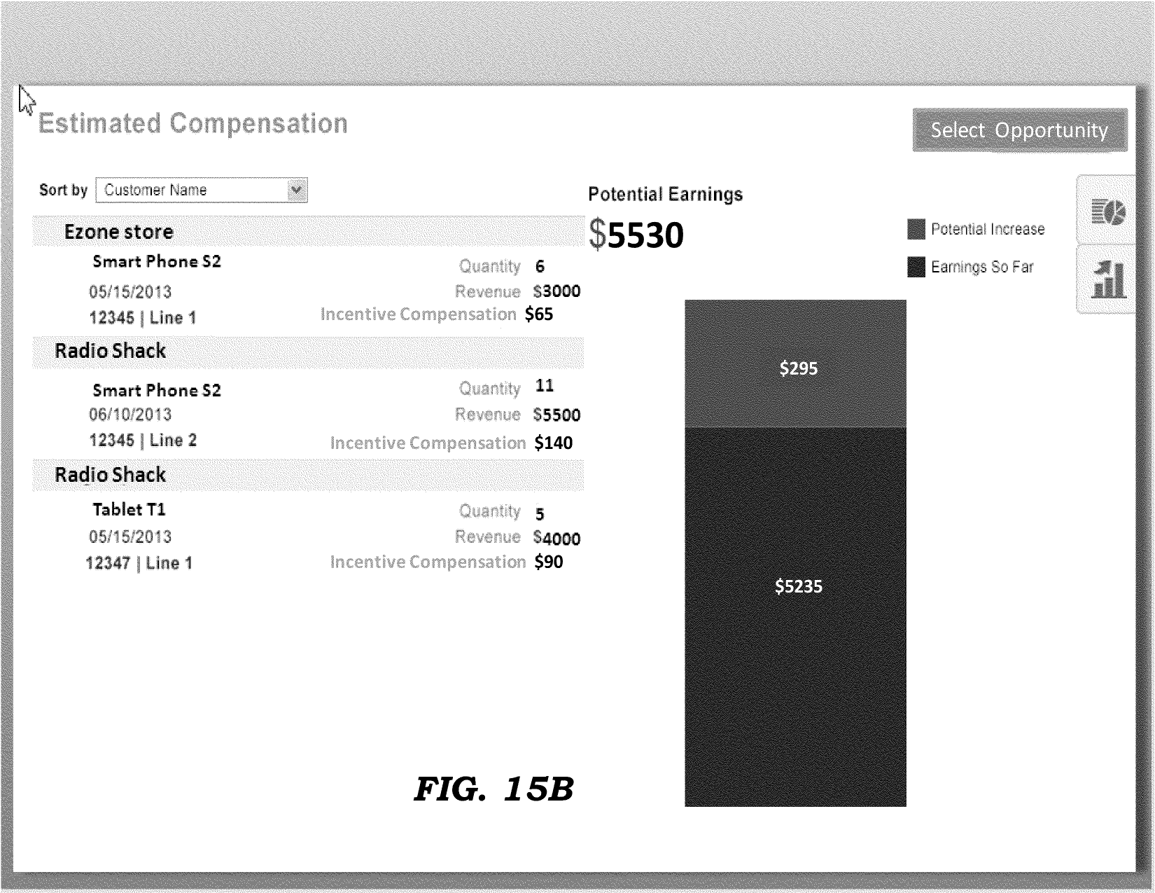

FIG. 15A depicts an example user interface using which a sales representative may view the list of opportunities available for being pursued. As shown there, four opportunity deals are shown displayed, each with some descriptive text and related revenue information. Kristin is shown having selected three of the displayed deals individual transaction amounts 4000, 5500, 3000 and requested estimate of compensation at 1510.

SPMS 150 uses the polynomial of FIG. 7, which would indicate respective measure values as 4000, 5500, 3000. These measure values are evaluated against the graph/polynomial of FIG. 8 to get respective estimates of 90, 140 and 65 (total of 295) for the first compensation plan described above. Estimates for individual transactions are provided based on the value of ‘N’ (i.e., not grouped/aggregated) in grouping column 1305 (assuming FIG. 13A is applicable). The actual earnings would be (4000*2%, 5500*3, and 3000*2%, with the corresponding total equaling 80+165+60=305). The differences may be acceptable, given the real time response in learning the estimate.

The display of FIG. 15B is accordingly shown to Kristin. The display indicates the incentive compensation for each of the opportunities, consistent with the calculations above. In addition, SPMS 150 is shown displaying the prior earned total incentive compensation, as computed and credited to Kristin (which is shown to be $5235) by compensation module 340 for the work performed by Kristin thus far. Thus, $5235 represents the incentive compensation already earned by Kristin and $295 the additional compensation that can be earned by pursuing the selected three opportunities.

As yet another example, assuming that Kristin selects opportunities with amounts 3000, 2900, and 4500 to project her incentive compensation, real-time query module 380 adds up these values (10400) (in view of ‘Y’ (aggregate) entry in column 1305) and picks the Measure attainment value (10400) from the above graph/polynomial of FIG. 11, assuming FIG. 13B is applicable. The 10400 obtained from FIG. 11 is evaluated against the graph/polynomial of FIG. 12 (Incentive vs. measure) to complete computation of the incentive. The polynomial provides a value of 450 for the incentives, while the actual/accurate earnings in accordance with FIGS. 9A/9B would have been 520.

It should be appreciated that the polynomials can be more accurate by factoring in additional data points and/or using higher degree polynomials, though only a few data points and second degree polynomials are shown as being considered in the description above.

It should be further appreciated that the features described above can be implemented in various embodiments as a desired combination of one or more of hardware, software, and firmware. The description is continued with respect to an embodiment in which various features are operative when the software instructions described above are executed.

### 8. Digital Processing System

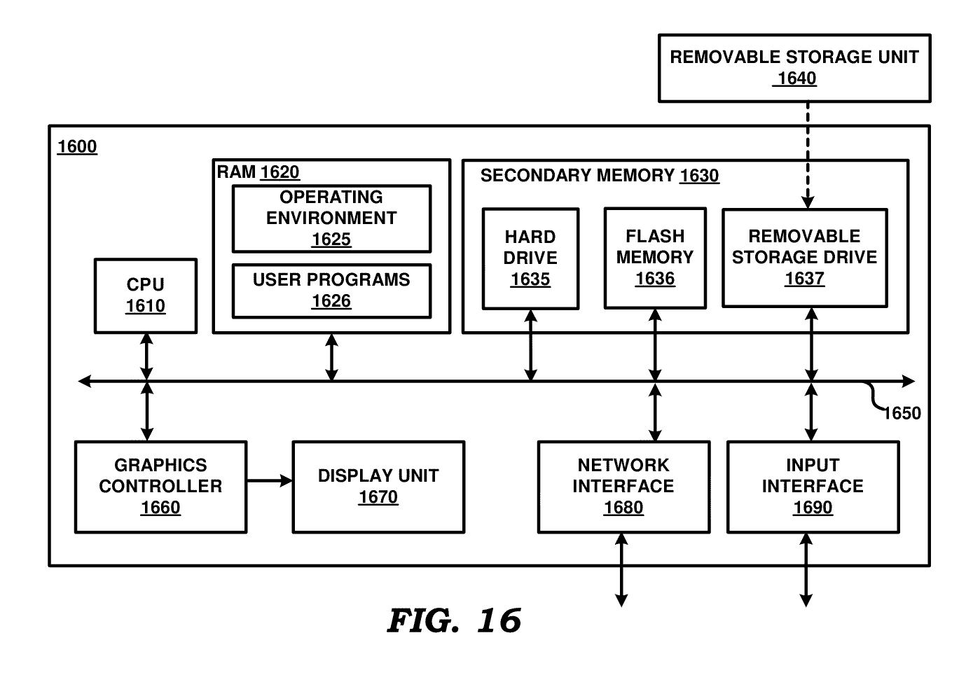

FIG. 16 is a block diagram illustrating the details of digital processing system 1600 in which various aspects of the present disclosure are operative by execution of appropriate software instructions. Digital processing system 1600 may correspond to SPMS 150. Digital processing system 1600 may contain one or more processors such as a central processing unit (CPU) 1610, random access memory (RAM) 1620, secondary memory 1630, graphics controller 1660, display unit 1670, network interface 1680, and input interface 1690. All the components except display unit 1670 may communicate with each other over communication path 1650, which may contain several buses as is well known in the relevant arts. The components of FIG. 16 are described below in further detail.

CPU 1610 may execute instructions stored in RAM 1620 to provide several features of the present disclosure. CPU 1610 may contain multiple processors, with each processor potentially being designed for a specific task. Alternatively, CPU 1610 may contain only a single general-purpose processor. Such combination of one or more processors may be generally referred to as a processing unit.

RAM 1620 may receive instructions from secondary memory 1630 using communication path 1650. RAM 1620 is shown currently containing software instructions constituting shared environment 1625 and/or user programs 1626 (such as the modules/blocks shown in FIG. 3). Shared environment 1625 includes operating systems, device drivers, virtual machines, RDBMS, etc., which provide a (common) run time environment for execution of user programs 1626.

Graphics controller 1660 generates display signals (e.g., in RGB format) to display unit 1670 based on data/instructions received from CPU 1610. Display unit 1670 contains a display screen to display the images defined by the display signals. Input interface 1690 may correspond to a keyboard and a pointing device (e.g., touch-pad, mouse), which may be used to provide inputs. Network interface 1680 provides connectivity to a network (e.g., using Internet Protocol), and may be used to communicate with other systems (such as those shown in FIG. 1) connected to the network.

Secondary memory 1630 may contain hard drive 1635, flash memory 1636, and removable storage drive 1637. Secondary memory 1630 may store the data and software instructions (e.g., for performing the actions noted above with respect to FIG. 2), which enable digital processing system 1600 to provide several features in accordance with the present disclosure.

Some or all of the data and instructions may be provided on removable storage unit 1640, and the data and instructions may be read and provided by removable storage drive 1637 to CPU 1610. Floppy drive, magnetic tape drive, CD-ROM drive, DVD Drive, Flash memory, removable memory chip (PCMCIA Card, EEPROM) are examples of such removable storage drive 1637.

Removable storage unit 1640 may be implemented using medium and storage format compatible with removable storage drive 1637 such that removable storage drive 1637 can read the data and instructions. Thus, removable storage unit 1640 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 1640 or hard disk installed in hard drive 1635. These computer program products are means for providing software to digital processing system 1600. CPU 1610 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 1630. Volatile media includes dynamic memory, such as RAM 1620. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1650. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

### 9. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method implemented in a sales performance management system, said method comprising:
receiving data indicating completion of a plurality of sales transactions by a plurality of sales representatives;
computing incentive compensation for said plurality of sales representatives based on said plurality of transactions;
formulating, for each of said plurality of sales representatives, a respective polynomial of a plurality of polynomials modelling said incentive compensation computed for said plurality of transactions;
receiving an opportunity for a first sales representative of said plurality of sales representatives;
identifying a polynomial of said plurality of polynomials corresponding to said first sales representative;
estimating an incentive compensation for said first sales representative in relation to said opportunity based on said polynomial.

2. The method of claim 1, wherein said opportunity is received from said first sales representative, and said method further comprises sending for display said estimated incentive compensation as a response to receiving of said opportunity from said first sales representative.

3. The method of claim 2, wherein said computing is performed in a batch mode for many of said plurality of transactions together, and said estimating is performed upon receiving said opportunity such that the estimated incentive compensation is received in real time by said first sales representative.

4. The method of claim 3, further comprising:
maintaining a plurality of compensation plans, with each compensation plan specifying a corresponding measure formula and an incentive formula, said measure formula being based on revenue realized for the transaction and said incentive formula being based on measure computed from the measure formula,
wherein said formulating formulates a first polynomial for said measure based on said revenue, and a second polynomial for said incentive compensation based on said measure.

5. The method of claim 4, wherein said maintaining maintains a corresponding compensation plan for each combination of a sales representative and a product,
a corresponding combination of said first polynomial and said second polynomial are computed for each combination of said sales representative and said product,
wherein said first polynomial and said second polynomial are stored in a non-volatile memory.

6. The method of claim 4, wherein each of said first polynomial and said second polynomial is formulated as a quadratic expression.

7. The method of claim 3, wherein a previously earned incentive compensation for prior work computed in said batch mode is also sent for display, wherein said previously earned incentive compensation is displayed simultaneously along with said estimated incentive compensation.

8. A non-transitory machine readable medium storing one or more sequences of instructions for causing a server system to facilitate management of sales performance, wherein execution of said one or more sequences of instructions by one or more processors contained in said server system causes said server system to perform the actions of:
receiving data indicating completion of a plurality of sales transactions by a plurality of sales representatives;
computing incentive compensation for said plurality of sales representatives based on said plurality of transactions;
formulating, for each of said plurality of sales representatives, a respective polynomial of a plurality of polynomials modelling said incentive compensation computed for said plurality of transactions;
receiving an opportunity for a first sales representative of said plurality of sales representatives;
identifying a polynomial of said plurality of polynomials corresponding to said first sales representative;
estimating an incentive compensation for said first sales representative in relation to said opportunity based on said polynomial.

9. The non-transitory machine readable medium of claim 8, wherein said opportunity is received from said first sales representative, and said actions further comprise sending for display said estimated incentive compensation as a response to receiving of said opportunity from said first sales representative.

10. The non-transitory machine readable medium of claim 9, wherein said computing is performed in a batch mode for many of said plurality of transactions together, and said estimating is performed upon receiving said opportunity such that the estimated incentive compensation is received in real time by said first sales representative.

11. The non-transitory machine readable medium of claim 10, further comprising:
maintaining a plurality of compensation plans, with each compensation plan specifying a corresponding measure formula and an incentive formula, said measure formula being based on revenue realized for the transaction and said incentive formula being based on measure computed from the measure formula,
wherein said formulating formulates a first polynomial for said measure based on said revenue, and a second polynomial for said incentive compensation based on said measure.

12. The non-transitory machine readable medium of claim 11, wherein said maintaining maintains a corresponding compensation plan for each combination of a sales representative and a product,
a corresponding combination of said first polynomial and said second polynomial are computed for each combination of said sales representative and said product,
wherein said first polynomial and said second polynomial are stored in a non-volatile memory.

13. The non-transitory machine readable medium of claim 11, wherein each of said first polynomial and said second polynomial is formulated as a quadratic expression.

14. The non-transitory machine readable medium of claim 10, wherein a previously earned incentive compensation for prior work computed in said batch mode is also sent for display, wherein said previously earned incentive compensation is displayed simultaneously along with said estimated incentive compensation.

15. A sales performance management system (SPMS) comprising:
a memory to store instructions;
a processing unit to retrieve and execute said instructions to cause said SPMS perform the actions of:
receiving data indicating completion of a plurality of sales transactions by a plurality of sales representatives;
computing incentive compensation for said plurality of sales representatives based on said plurality of transactions;
formulating, for each of said plurality of sales representatives, a respective polynomial of a plurality of polynomials modelling said incentive compensation computed for said plurality of transactions;
receiving an opportunity for a first sales representative of said plurality of sales representatives;
identifying a polynomial of said plurality of polynomials corresponding to said first sales representative;
estimating an incentive compensation for said first sales representative in relation to said opportunity based on said polynomial.

16. The SPMS of claim 15, wherein said computing is performed in a batch mode for many of said plurality of transactions together, and said estimating is performed upon receiving said opportunity such that the estimated incentive compensation is received in real time by said first sales representative.

17. The SPMS of claim 16, wherein said opportunity is received from said first sales representative, and said actions further comprise sending for display said estimated incentive compensation and a previously earned incentive compensation as a response to receiving of said opportunity from said first sales representative,
wherein said previously earned incentive compensation is for prior work computed in said batch mode, wherein said previously earned incentive compensation is displayed simultaneously along with said estimated incentive compensation.

18. The SPMS of claim 17, further comprising:
maintaining a plurality of compensation plans, with each compensation plan specifying a corresponding measure formula and an incentive formula, said measure formula being based on revenue realized for the transaction and said incentive formula being based on measure computed from the measure formula,
wherein said formulating formulates a first polynomial for said measure based on said revenue, and a second polynomial for said incentive compensation based on said measure.

19. The SPMS of claim 18, wherein said maintaining maintains a corresponding compensation plan for each combination of a sales representative and a product,
a corresponding combination of said first polynomial and said second polynomial are computed for each combination of said sales representative and said product,
wherein said first polynomial and said second polynomial are stored in a non-volatile memory.

20. The SPMS of claim 18, wherein each of said first polynomial and said second polynomial is formulated as a quadratic expression.
